(19) United States
(12) Patent Application Publication
(10) Pub. No.: US 2026/0339533 A1
(43) Pub. Date: Oct. 29, 2026

(54) System and Method for Configuring Connections within Back-end Storage Fabrics

(71) Applicant: Dell Products L.P., Round Rock, TX (US)

(72) Inventors: Yuanyang Wu, Shanghai (CN); Prakash Venkatanarayanan, Millbury, MA (US); Girish Sheelvant, Hopkinton, MA (US); Nagapraveen V. Seela, Cary, NC (US); Fei Long, Shanghai (CN); Yingmei Song, Shanghai (CN)

(21) Appl. No.: 19/189,809

(22) Filed: Apr. 25, 2025

(51) Int. Cl. G06F 3/06

(52) U.S. Cl. CPC G06F 3/0635; G06F 3/0604; G06F 3/067

(57) ABSTRACT

A method, computer program product, and computing system for identifying a first back-end storage system and a second back-endstorage system communicatively coupled together within a storage fabric. A port group is generated including a first subset of ports from a plurality of ports of the first back-end storage system and a second subset of ports from a plurality of ports of the second back-end storage system. A connection is configured only between the first subset of ports from the first back-end storage system and the second subset of ports from the second back-end storage system as defined in the port group.

### BACKGROUND

Storing and safeguarding electronic content may be beneficial in modern business and elsewhere. Accordingly, various methodologies may be employed to protect and distribute such electronic content.

For example, in an initiator-target based network (e.g., SCSI over Fibre Channel (FC), NVMe-oF/FC, etc.), it is common that all initiators on hosts login to all possible targets on storage systems. For all data-mobility operations (e.g., replication and migration) between storage systems, which have dual-role ports supporting both target (which allows host initiators and remote storage system initiators to connect to access the storage) and initiator (which connects to remote storage system targets), network connections between ports on storage systems must be configured.

### SUMMARY OF DISCLOSURE

In one example implementation, a computer-implemented method executed on a computing device may include, but is not limited to, identifying a first back-end storage system and a second back-end storage system communicatively coupled together within a storage fabric. A port group is generated including a first subset of ports from a plurality of ports of the first back-end storage system and a second subset of ports from a plurality of ports of the second back-end storage system. A connection is configured only between the first subset of ports from the first back-end storage system and the second subset of ports from the second back-end storage system as defined in the port group.

One or more of the following example features may be included. Generating the port group may include defining a directionality of the connection between the first subset of ports of the first back-end storage system and the second subset of ports of the second back-end storage system. The directionality of the connection may be unidirectional from the first subset of ports of the first back-end storage system to the second subset of ports of the second back-end storage system. The directionality of the connection may be bidirectional between the first subset of ports of the first back-end storage system and the second subset of ports of the second back-end storage system. A zone group including one or more ports from the plurality of ports of the first back-end storage system and one or more ports from the plurality of ports of the second back-end storage system may be processed, where the zone group may be defined for a switch within the storage fabric. Configuring the connection only between the first subset of ports from the first back-end storage system and the second subset of ports from the second back-end storage system may include configuring the connection only between the first subset of ports from the first back-end storage system and the second subset of ports from the second back-end storage system that are included in the zone group. The storage fabric may be a Fibre Channel (FC) storage fabric, and the first back-end storage system and the second back-end storage system form a FC storage area network (SAN).

In another example implementation, a computer program product resides on a computer readable medium that has a plurality of instructions stored on it. When executed by a processor, the instructions cause the processor to perform operations that may include, but are not limited to, identifying a first back-end storage system and a second back-end storage system communicatively coupled together within a storage fabric. A port group is generated including a first subset of ports from a plurality of ports of the first back-end storage system and a second subset of ports from a plurality of ports of the second back-end storage system. A connection is configured only between the first subset of ports from the first back-end storage system and the second subset of ports from the second back-end storage system as defined in the port group.

One or more of the following example features may be included. Generating the port group may include defining a directionality of the connection between the first subset of ports of the first back-end storage system and the second subset of ports of the second back-end storage system. The directionality of the connection may be unidirectional from the first subset of ports of the first back-end storage system to the second subset of ports of the second back-end storage system. The directionality of the connection may be bidirectional between the first subset of ports of the first back-end storage system and the second subset of ports of the second back-end storage system. A zone group including one or more ports from the plurality of ports of the first back-end storage system and one or more ports from the plurality of ports of the second back-end storage system may be processed, where the zone group may be defined for a switch within the storage fabric. Configuring the connection only between the first subset of ports from the first back-end storage system and the second subset of ports from the second back-end storage system may include configuring the connection only between the first subset of ports from the first back-end storage system and the second subset of ports from the second back-end storage system that are included in the zone group. The storage fabric may be a Fibre Channel (FC) storage fabric, and the first back-end storage system and the second back-end storage system form a FC storage area network (SAN).

In another example implementation, a computing system includes at least one processor and at least one memory architecture coupled with the at least one processor, wherein the at least one processor is configured to identify a first back-end storage system and a second back-end storage system communicatively coupled together within a storage fabric. A port group is generated including a first subset of ports from a plurality of ports of the first back-end storage system and a second subset of ports from a plurality of ports of the second back-end storage system. A connection is configured only between the first subset of ports from the first back-end storage system and the second subset of ports from the second back-end storage system as defined in the port group.

One or more of the following example features may be included. Generating the port group may include defining a directionality of the connection between the first subset of ports of the first back-end storage system and the second subset of ports of the second back-end storage system. The directionality of the connection may be unidirectional from the first subset of ports of the first back-end storage system to the second subset of ports of the second back-end storage system. The directionality of the connection may be bidirectional between the first subset of ports of the first back-end storage system and the second subset of ports of the second back-end storage system. A zone group including one or more ports from the plurality of ports of the first back-end storage system and one or more ports from the plurality of ports of the second back-end storage system may be processed, where the zone group may be defined for a switch within the storage fabric. Configuring the connection only between the first subset of ports from the first back-end storage system and the second subset of ports from the second back-end storage system may include configuring the connection only between the first subset of ports from the first back-end storage system and the second subset of ports from the second back-end storage system that are included in the zone group. The storage fabric may be a Fibre Channel (FC) storage fabric, and the first back-end storage system and the second back-end storage system form a FC storage area network (SAN).

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a storage fabric management process coupled to a distributed computing network according to one or more example implementations of the disclosure;

FIG. 2 is an example diagrammatic view of the storage system of FIG. 1 according to one or more example implementations of the disclosure;

FIG. 3 is an example flowchart of the storage fabric management process of FIG. 1 according to one or more example implementations of the disclosure; and

FIGS. 4-9 are example diagrammatic views of the storage fabric management process of FIG. 1 according to various example implementations of the disclosure.

Like reference symbols in the various drawings indicate like elements.

### DETAILED DESCRIPTION

### System Overview

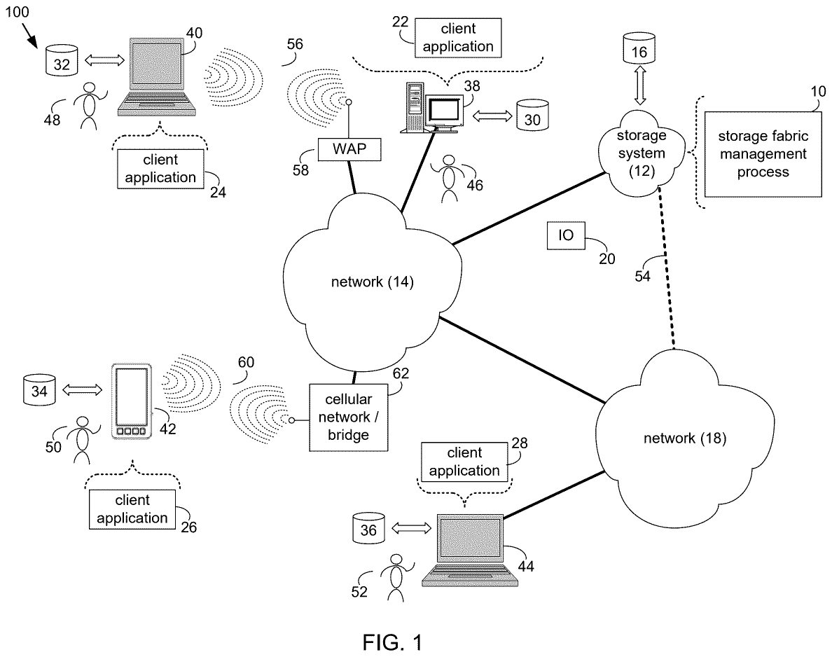

Referring to FIG. 1, there is shown storage fabric management process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a minicomputer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of storage fabric management process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random-access memory (RAM); a read-only memory (ROM); and all forms of flash memory storage devices. Additionally/alternatively, some portions of the instruction sets and subroutines of storage fabric management process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g., IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, an storage fabric management process, such as storage fabric management process 10 of FIG. 1, may include but is not limited to, identifying a first back-end storage system and a second back-end storage system communicatively coupled together within a storage fabric. A port group is generated including a first subset of ports from a plurality of ports of the first back-end storage system and a second subset of ports from a plurality of ports of the second back-end storage system. A connection is configured only between the first subset of ports from the first back-end storage system and the second subset of ports from the second back-end storage system as defined in the port group.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Storage System

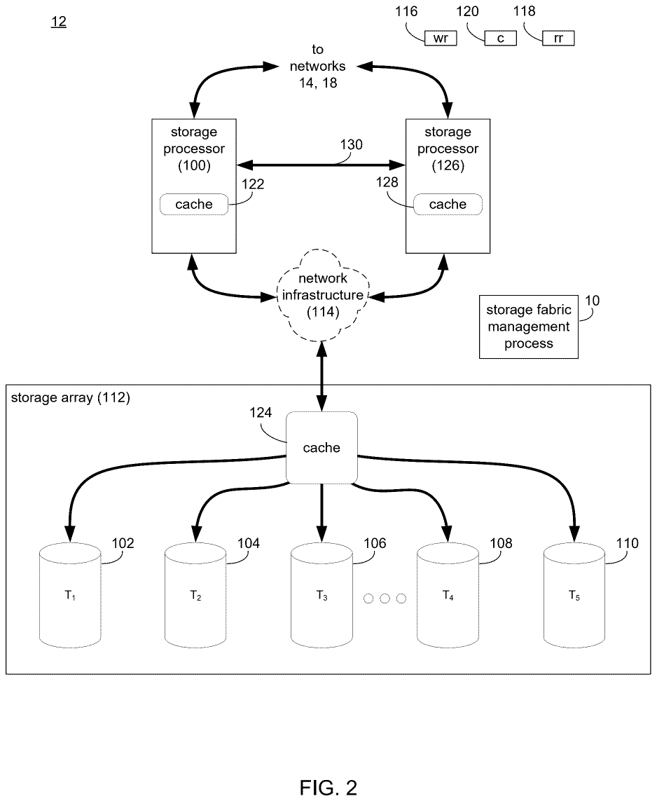

Referring also to FIG. 2, storage system 12 may include storage processor 100 and a plurality of storage targets T 1-n (e.g., storage targets 102, 104, 106, 108). Storage targets 102, 104, 106, 108 may be configured to provide various levels of performance and/or high availability. For example, one or more of storage targets 102, 104, 106, 108 may be configured as a RAID 0 array, in which data is striped across storage targets. By striping data across a plurality of storage targets, improved performance may be realized. However, RAID 0 arrays do not provide a level of high availability. Accordingly, one or more of storage targets 102, 104, 106, 108 may be configured as a RAID 1 array, in which data is mirrored between storage targets. By mirroring data between storage targets, a level of high availability is achieved as multiple copies of the data are stored within storage system 12.

While storage targets 102, 104, 106, 108 are discussed above as being configured in a RAID 0 or RAID 1 array, this is for example purposes only and is not intended to be a limitation of this disclosure, as other configurations are possible. For example, storage targets 102, 104, 106, 108 may be configured as a RAID 3, RAID 4, RAID 5 or RAID 6 array.

While in this particular example, storage system 12 is shown to include four storage targets (e.g., storage targets 102, 104, 106, 108), this is for example purposes only and is not intended to be a limitation of this disclosure. Specifically, the actual number of storage targets may be increased or decreased depending upon e.g., the level of redundancy/performance/capacity required.

Storage system 12 may also include one or more coded targets 110. As is known in the art, a coded target may be used to store coded data that may allow for the regeneration of data lost/corrupted on one or more of storage targets 102, 104, 106, 108. An example of such a coded target may include but is not limited to a hard disk drive that is used to store parity data within a RAID array.

While in this particular example, storage system 12 is shown to include one coded target (e.g., coded target 110), this is for example purposes only and is not intended to be a limitation of this disclosure. Specifically, the actual number of coded targets may be increased or decreased depending upon e.g., the level of redundancy/performance/capacity required.

Examples of storage targets 102, 104, 106, 108 and coded target 110 may include one or more electro-mechanical hard disk drives and/or solid-state/flash devices, wherein a combination of storage targets 102, 104, 106, 108 and coded target 110 and processing/control systems (not shown) may form data array 112.

The manner in which storage system 12 is implemented may vary depending upon e.g., the level of redundancy/performance/capacity required. For example, storage system 12 may be a RAID device in which storage processor 100 is a RAID controller card and storage targets 102, 104, 106, 108 and/or coded target 110 are individual “hot-swappable” hard disk drives. Another example of such a RAID device may include but is not limited to an NAS device. Alternatively, storage system 12 may be configured as a SAN, in which storage processor 100 may be e.g., a server computer and each of storage targets 102, 104, 106, 108 and/or coded target 110 may be a RAID device and/or computer-based hard disk drives. Further still, one or more of storage targets 102, 104, 106, 108 and/or coded target 110 may be a SAN.

In the event that storage system 12 is configured as a SAN, the various components of storage system 12 (e.g. storage processor 100, storage targets 102, 104, 106, 108, and coded target 110) may be coupled using network infrastructure 114, examples of which may include but are not limited to an Ethernet (e.g., Layer 2 or Layer 3) network, a fiber channel network, an InfiniBand network, or any other circuit switched/packet switched network.

Storage system 12 may execute all or a portion of storage fabric management process 10. The instruction sets and subroutines of storage fabric management process 10, which may be stored on a storage device (e.g., storage device 16) coupled to storage processor 100, may be executed by one or more processors (not shown) and one or more memory architectures (not shown) included within storage processor 100. Storage device 16 may include but is not limited to: a hard disk drive; a tape drive; an optical drive; a RAID device; a random-access memory (RAM); a read-only memory (ROM); and all forms of flash memory storage devices. As discussed above, some portions of the instruction sets and subroutines of storage fabric management process 10 may be stored on storage devices (and/or executed by processors and memory architectures) that are external to storage system 12.

As discussed above, various IO requests (e.g., IO request 20) may be generated. For example, these IO requests may be sent from client applications 22, 24, 26, 28 to storage system 12. Additionally/alternatively and when storage processor 100 is configured as an application server, these IO requests may be internally generated within storage processor 100. Examples of IO request 20 may include but are not limited to data write request 116 (e.g., a request that content 118 be written to storage system 12) and data read request 120 (i.e., a request that content 118 be read from storage system 12).

During operation of storage processor 100, content 118 to be written to storage system 12 may be processed by storage processor 100. Additionally/alternatively and when storage processor 100 is configured as an application server, content 118 to be written to storage system 12 may be internally generated by storage processor 100.

Storage processor 100 may include frontend cache memory system 122. Examples of frontend cache memory system 122 may include but are not limited to a volatile, solid-state, cache memory system (e.g., a dynamic RAM cache memory system) and/or a non-volatile, solid-state, cache memory system (e.g., a flash-based, cache memory system).

Storage processor 100 may initially store content 118 within frontend cache memory system 122. Depending upon the manner in which frontend cache memory system 122 is configured, storage processor 100 may immediately write content 118 to data array 112 (if frontend cache memory system 122 is configured as a write-through cache) or may subsequently write content 118 to data array 112 (if frontend cache memory system 122 is configured as a write-back cache).

Data array 112 may include backend cache memory system 124. Examples of backend cache memory system 124 may include but are not limited to a volatile, solid-state, cache memory system (e.g., a dynamic RAM cache memory system) and/or a non-volatile, solid-state, cache memory system (e.g., a flash-based, cache memory system). During operation of data array 112, content 118 to be written to data array 112 may be received from storage processor 100. Data array 112 may initially store content 118 within backend cache memory system 124 prior to being stored on e.g., one or more of storage targets 102, 104, 106, 108, and coded target 110.

As discussed above, the instruction sets and subroutines of storage fabric management process 10, which may be stored on storage device 16 included within storage system 12, may be executed by one or more processors (not shown) and one or more memory architectures (not shown) included within storage system 12. Accordingly, in addition to being executed on storage processor 100, some or all of the instruction sets and subroutines of storage fabric management process 10 may be executed by one or more processors (not shown) and one or more memory architectures (not shown) included within data array 112.

Further and as discussed above, during the operation of data array 112, content (e.g., content 118) to be written to data array 112 may be received from storage processor 100 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

In some implementations, storage system 12 may include multi-node active/active storage clusters configured to provide high availability to a user. As is known in the art, the term “high availability” may generally refer to systems or components that are durable and likely to operate continuously without failure for a long time. For example, an active/active storage cluster may be made up of at least two nodes (e.g., storage processors 100, 126), both actively running the same kind of service(s) simultaneously. One purpose of an active-active cluster may be to achieve load balancing. Load balancing may distribute workloads across all nodes in order to prevent any single node from getting overloaded. Because there are more nodes available to serve, there will also be a marked improvement in throughput and response times. Another purpose of an active-active cluster may be to provide at least one active node in the event that one of the nodes in the active-active cluster fails.

In some implementations, storage processor 126 may function like storage processor 100. For example, during operation of storage processor 126, content 118 to be written to storage system 12 may be processed by storage processor 126. Additionally/alternatively and when storage processor 126 is configured as an application server, content 118 to be written to storage system 12 may be internally generated by storage processor 126.

Storage processor 126 may include frontend cache memory system 128. Examples of frontend cache memory system 128 may include but are not limited to a volatile, solid-state, cache memory system (e.g., a dynamic RAM cache memory system) and/or a non-volatile, solid-state, cache memory system (e.g., a flash-based, cache memory system).

Storage processor 126 may initially store content 118 within frontend cache memory system 126. Depending upon the manner in which frontend cache memory system 128 is configured, storage processor 126 may immediately write content 118 to data array 112 (if frontend cache memory system 128 is configured as a write-through cache) or may subsequently write content 118 to data array 112 (if frontend cache memory system 128 is configured as a write-back cache).

In some implementations, the instruction sets and subroutines of storage fabric management process 10, which may be stored on storage device 16 included within storage system 12, may be executed by one or more processors (not shown) and one or more memory architectures (not shown) included within storage system 12. Accordingly, in addition to being executed on storage processor 126, some or all of the instruction sets and subroutines of storage fabric management process 10 may be executed by one or more processors (not shown) and one or more memory architectures (not shown) included within data array 112.

Further and as discussed above, during the operation of data array 112, content (e.g., content 118) to be written to data array 112 may be received from storage processor 126 and initially stored within backend cache memory system 124 prior to being stored on e.g., one or more of storage targets 102, 104, 106, 108, 110. Accordingly, during use of data array 112, backend cache memory system 124 may be populated (e.g., warmed) and, therefore, subsequent read requests may be satisfied by backend cache memory system 124 (e.g., if the content requested in the read request is present within backend cache memory system 124), thus avoiding the need to obtain the content from storage targets 102, 104, 106, 108, 110 (which would typically be slower).

As discussed above, storage processor 100 and storage processor 126 may be configured in an active/active configuration where processing of data by one storage processor may be synchronized to the other storage processor. For example, data may be synchronized between each storage processor via a separate link or connection (e.g., connection 130).

### The Storage Fabric Management Process

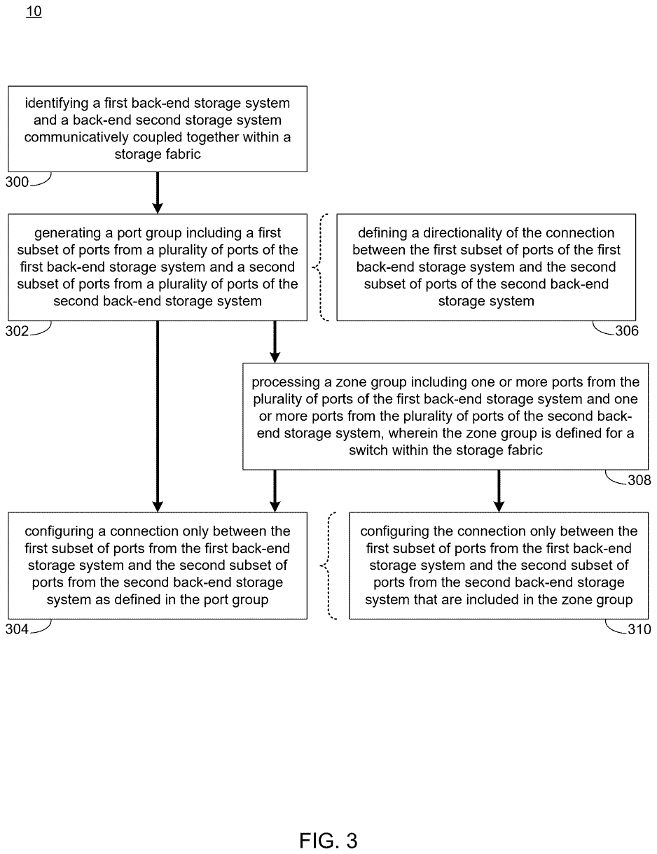

Referring also to FIGS. 3-5 and in some implementations, storage fabric management process 10 identifies 300 a first back-end storage system and a second back-end storage system communicatively coupled together within a storage fabric. A port group is generated 302 including a first subset of ports from a plurality of ports of the first back-end storage system and a second subset of ports from a plurality of ports of the second back-end storage system. A connection is configured 304 only between the first subset of ports from the first back-end storage system and the second subset of ports from the second back-end storage system as defined in the port group.

For example, in a storage fabric, storage devices are connected directly and/or across switches according to a particular fabric protocol (e.g., SCSI over Fibre Channel (FC), NVMe-oF/FC, etc.). In this configuration, storage arrays perform dual roles both as storage targets and initiators that connect to other storage targets. With conventional discovery and connection processes, all initiators are connected to all targets, causing scale and performance issues. Even in situations involving a selective connection to particular targets, a storage administrator on host, wishing to manage a particular back-end storage device, is unable to ascertain storage devices that are accessible to the back-end storage device within the storage system and manage the connections from that back-end storage device across the storage fabric.

Implementations of the present disclosure allow users (e.g., storage administrators) to configure connections between ports of storage processors of various storage systems based on groups of ports (e.g., “port groups”). For example, conventional approaches are unable to provide effective means for configuring network connections between multiple storage systems. Accordingly, storage fabric management process 10 defines port groups that automatically configure network connections between ports for different data mobility operations. In one example, a port group can be defined to indicate a set of ports on a first storage system for migrating data to a set of ports on a second storage system. In another example, a port group can be defined by storage fabric management process 10 to configure bidirectional connections between particular ports of the first and second storage systems. In yet another example, a port group can be defined by storage fabric management process 10 to account for switch-defined zone groups.

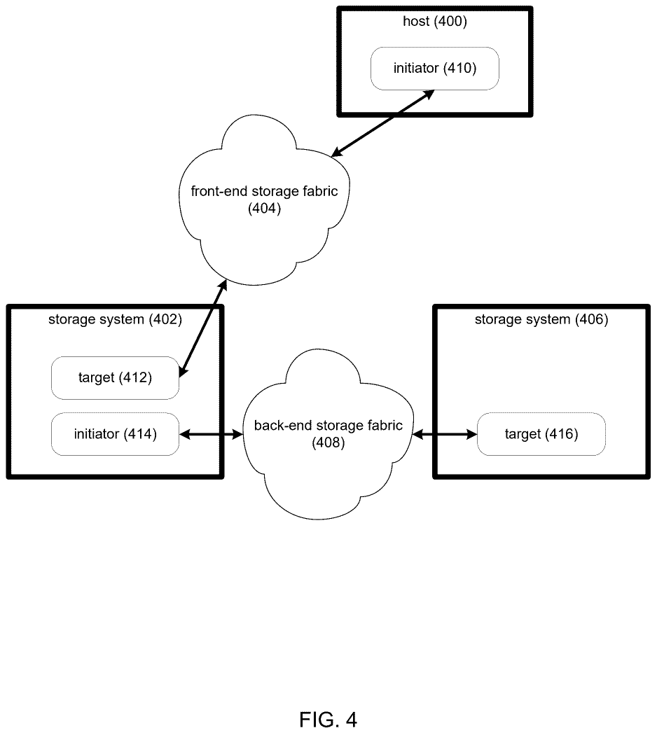

In some implementations, storage fabric management process 10 identifies 300 a first back-end storage system and a second back-end storage system communicatively coupled together within a storage fabric. For example and referring also to FIG. 4, a storage system (e.g., storage system 12) is configured with a storage fabric. A storage fabric is a network architecture designed to connect storage devices to servers and hosts. In one example, the portion of the storage fabric that couples front-end devices (e.g., host 400) with back-end storage systems (e.g., storage system 402) is referred to as front-end storage fabric 404. The portion of the storage fabric that couples back-end storage systems (e.g., storage systems 402, 406) is referred to as back-end storage fabric 408. The storage fabric (e.g., front-end storage fabric 404 and back-end storage fabric 408) provides a high-speed, reliable, and scalable method for data transfer between these components. Storage fabrics are essential in data centers and enterprise environments where large volumes of data need to be managed efficiently. Fibre Channel is an example of the storage fabric. It is a high-speed network technology primarily used for storage networking. Fibre Channel provides a dedicated, high-performance pathway for data transfer, which is crucial for applications requiring fast and reliable access to large datasets, such as databases and virtualized environments.

Accordingly and in one example, storage fabrics 404, 408 and storage systems (e.g., storage system 402, 406) define a Fibre Channel (FC) Storage Area Network (SAN) with a host (e.g., host 400). While the example of FIG. 4 includes two storage systems (e.g., storage systems 402, 406), it will be appreciated that this is for example purposes only and that any number of storage devices may be deployed within the storage fabric within the scope of the present disclosure. Additionally, while an example of Fibre Channel has been described for the storage fabric, it will be appreciated that other types of storage fabrics (e.g., SCSI over Fibre Channel (FC), NVMe-oF/FC, etc.) may be used within the scope of the present disclosure.

In some implementations, in a storage fabric, devices can be initiators and/or targets. In one example, host 400 initiates a connection to back-end storage system 402 across front-end storage fabric 404. In this example, host 400 is the initiator (e.g., initiator 410) and back-end storage system 402 is the target (e.g., target 412) where data is communicated across front-end storage fabric 404 from host 400 to back-end storage system 402. In another example, data is migrated from one back-end storage system to another. Accordingly and in this example, back-end storage system 402 is configured by storage fabric management process 10 to be the initiator (i.e., initiator 414) and back-end storage system 406 is configured to be the target (e.g., target 416). In some implementations, storage fabric management process 10 discovers the target storage devices that are accessible to back-end storage device 402. As the storage devices that are accessible to host 400 may be different than the storage devices accessible to initiator 414 of back-end storage system 402, storage fabric management process 10 discovers storage devices that are accessible to initiator 414 of back-end storage system 402. In some implementations, initiator 414 and target 416 are software and/or hardware components that configure connections between storage systems and hosts.

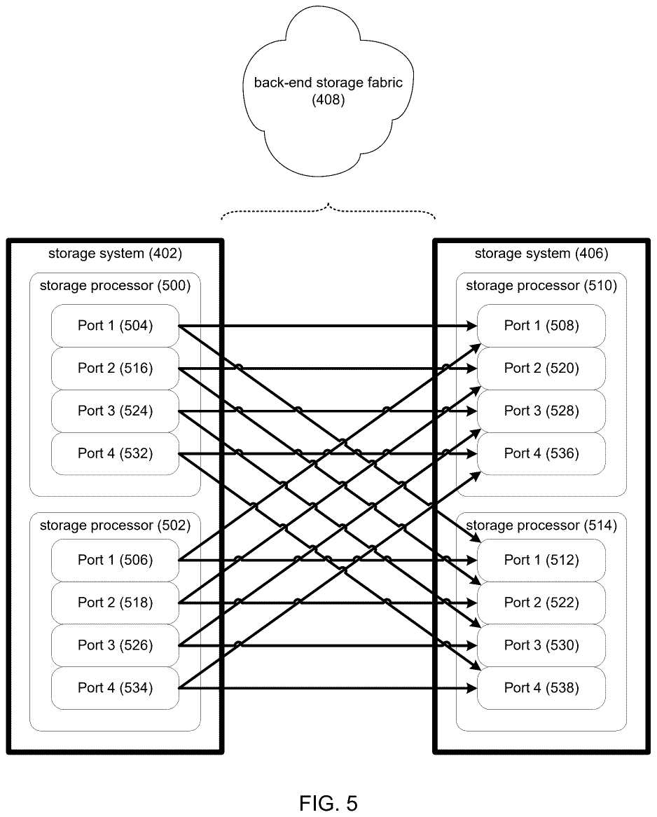

In some implementations, storage fabric management process 10 generates 302 a port group including a first subset of ports from a plurality of ports of the first back-end storage system and a second subset of ports from a plurality of ports of the second back-end storage system. A port group is a logical subset of the ports from a plurality of ports from at least a pair of back-end storage systems that are configured for specific connections. Ports of a port group are configured to only connect with other ports of the port group. Referring also to FIG. 5, storage system 402 includes two storage processors (e.g., storage processors 500, 502) each with e.g., four ports. A port is a software and/or hardware component that enables data to enter and/or exit a storage processor. For example, a connection between a port (e.g., port 1 504) of storage processor 500 and another port (e.g., port 1 506) of storage processor 500 of storage system 402, allows data to be communicated between storage processor 500 and storage processor 502.

In some implementations, storage fabric management process 10 generates 302 a port group by receiving selections from a user for a number of ports and/or a particular selection of ports to include in a port group. In one example, storage fabric management process 10 renders a user interface with all ports of an initiator and target available for selection and associates each selected port in a port group. In another example, storage fabric management process 10 generates a port group using an automatically defined subset of ports from a first back-end storage system (e.g., storage system 402) and a second back-end storage system (e.g., storage system 406). For instance, storage fabric management process 10 may automatically select an equal number of unassigned ports from each storage system to define a port group.

Referring again to FIG. 5, storage fabric management process 10 generates 302 a port group using Port 1 of each storage processor in the first back-end storage system and the second back-end storage system. In this example, storage fabric management process 10 generates 302 the port group to include Port 1 504 of storage processor 500 and Port 1 506 of storage processor 502 of storage system 402 and Port 1 508 of storage processor 510 and Port 1 512 of storage processor 514 of storage system 406. In another example, storage fabric management process 10 generates 302 a port group using Port 2 of each storage processor in the first back-end storage system and the second back-end storage system. In this example, storage fabric management process 10 generates 302 the port group to include Port 2 516 of storage processor 500 and Port 2 518 of storage processor 502 of storage system 402 and Port 2 520 of storage processor 510 and Port 2 522 of storage processor 514 of storage system 406. Similarly, storage fabric management process 10 generates 302 a port group to include Port 3 524 of storage processor 500 and Port 3 526 of storage processor 502 of storage system 402 and Port 3 528 of storage processor 510 and Port 3 530 of storage processor 514 of storage system 406; and a port group to include Port 4 532 of storage processor 500 and Port 4 534 of storage processor 502 of storage system 402 and Port 4 536 of storage processor 510 and Port 4 538 of storage processor 514 of storage system 406.

In some implementations, generating 302 the port group includes defining 306 a directionality of the connection between the first subset of ports of the first back-end storage system and the second subset of ports of the second back-end storage system. For example, when generating 302 the above-mentioned port groups, storage fabric management process 10 defines a directionality of the connection. In some implementations, directionality is the direction in which data flows in the connection between ports. In one example, defining 306 the directionality includes defining a source storage system. For example, if the source storage system is defined as a single storage system, the directionality is unidirectional from the source storage system to a target storage system. In this manner, data only flows from the source storage system to the target storage system. In another example, if the source storage system is defined as multiple storage systems, the directionality is bidirectional (in the case of two storage systems) or omnidirectional (in the case of more than two storage systems). In some implementations, storage fabric management process 10 receives a user selection of directionality when generating each port group.

In some implementations, storage fabric management process 10 defines 306 the directionality of the connection as unidirectional from the first subset of ports of the first back-end storage system to the second subset of ports of the second back-end storage system. Referring again to FIG. 5, storage fabric management process 10 defines 306 the directionality of the connection for the port group generated with Port 1 504 of storage processor 500 and Port 1 506 of storage processor 502 of storage system 402 and Port 1 508 of storage processor 510 and Port 1 512 of storage processor 514 of storage system 406 as unidirectional from source storage system 402. This is represented in FIG. 5 using unidirectional arrows from ports of source storage system 402 to ports of storage system 406. In some implementations, unidirectional connections are associated with migration of data from the source storage system to a target storage system.

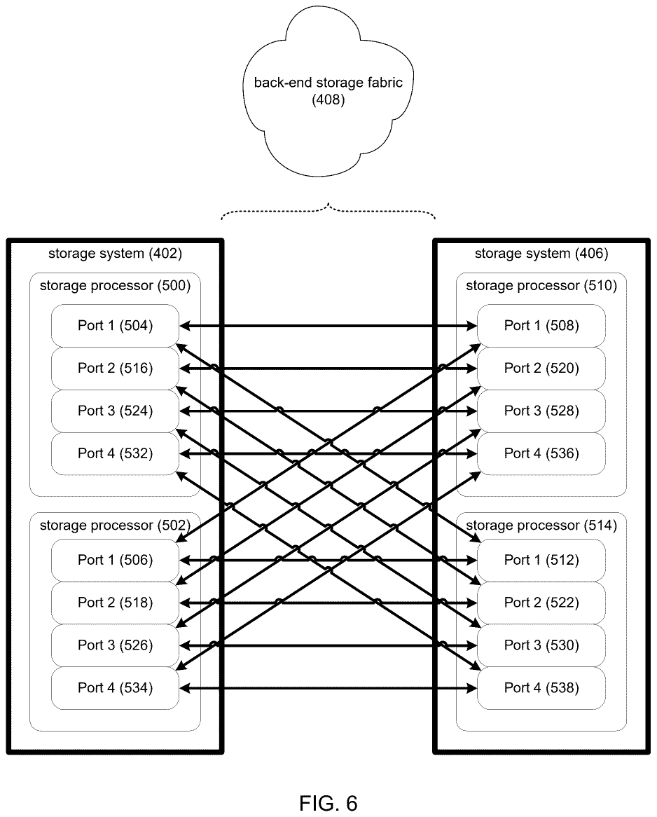

In some implementations, storage fabric management process 10 defines 306 the directionality of the connection as bidirectional between the first subset of ports of the first back-end storage system and the second subset of ports of the second back-end storage system. Referring also to FIG. 6, storage fabric management process 10 defines 306 the directionality of the connection for the port group generated with Port 1 504 of storage processor 500 and Port 1 506 of storage processor 502 of storage system 402 and Port 1 508 of storage processor 510 and Port 1 512 of storage processor 514 of storage system 406 as bidirectional from source storage system 402. This is represented in FIG. 6 using unidirectional arrows from ports of source storage system 402 to ports of storage system 406. In some implementations, unidirectional connections are associated with communication of data from between both storage systems (e.g., for load balancing, high availability, etc.).

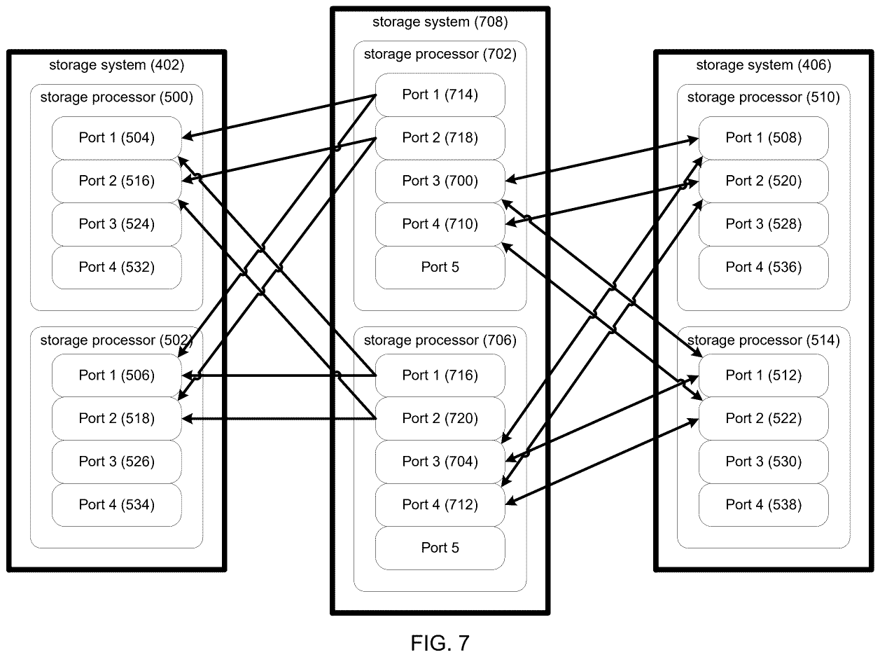

In some implementations, storage fabric management process 10 configures 304 a connection only between the first subset of ports from the first back-end storage system and the second subset of ports from the second back-end storage system as defined in the port group. In some implementations and as shown in FIGS. 5-7, storage fabric management process 10 configures 304 connections only between the ports from the first back-end storage system and from the second back-end storage system as defined in the port group. For example, as shown in FIGS. 5-6, storage fabric management process 10 configures 304 connections only between Port 1 504 of storage processor 500 and Port 1 506 of storage processor 502 of storage system 402 and Port 1 508 of storage processor 510 and Port 1 512 of storage processor 514 of storage system 406. Similarly, storage fabric management process 10 configures 304 connections only between respective Port 2, Port 3, Port 4 of each storage processor of both storage systems in separate port groups (e.g., a port group for Port 2 ports, a port group for Port 3 ports, and a port group for Port 4 ports). While the examples of FIGS. 5-6 include generating 300 port groups with the same ports (e.g., “Port 1”) from each storage processor, this is for example purposes only. For instance, in FIG. 7, storage fabric management process 10 generates 300 port groups including Port 3 700 of storage processor 702 and Port 3 704 of storage processor 706 of storage system 708 and Port 1 508 of storage processor 510 and Port 1 512 of storage processor 514 of storage system 406; and Port 4 710 of storage processor 702 and Port 4 712 of storage processor 706 of storage system 708 and Port 2 520 of storage processor 510 and Port 2 522 of storage processor 514 of storage system 406.

In some implementations, storage fabric management process 10 configures 304 connections only between the first subset of ports from the first back-end storage system and the second subset of ports from the second back-end storage system as defined in the port group for various data mobility operations. Referring again to FIG. 7, multiple port groups enable efficient configuration of network connections for storage system 708 with storage systems 402 and 406. For example, a first port group (e.g., Port 1 714 of storage processor 702 and Port 1 716 of storage processor 706 of storage system 708 and Port 1 504 of storage processor 500 and Port 1 506 of storage processor 502 of storage system 402) and a second port group (e.g., Port 2 718 of storage processor 702 and Port 2 720 of storage processor 706 of storage system 708 and Port 2 516 of storage processor 500 and Port 2 518 of storage processor 502 of storage system 402) are generated for unidirectional network connections that migrates data from storage system 708 to storage system 402. Further, the third port group (e.g., Port 3 700 of storage processor 702 and Port 3 704 of storage processor 706 of storage system 708 and Port 1 508 of storage processor 510 and Port 1 512 of storage processor 514 of storage system 406) and a fourth port group (e.g., Port 4 710 of storage processor 702 and Port 4 712 of storage processor 706 of storage system 708 and Port 2 520 of storage processor 510 and Port 2 522 of storage processor 514 of storage system 406) are generated for bidirectional network connections that replicates data between storage system 708 and storage system 706. Accordingly, storage fabric management process 10 configures 304 connections between storage systems 708, 402, 406 for different data mobility operations within the scope of the present disclosure.

In some implementations, storage fabric management process 10 processes 308 a zone group including one or more ports from the plurality of ports of the first back-end storage system and one or more ports from the plurality of ports of the second back-end storage system, wherein the zone group is defined for a switch within the storage fabric. For example, a zone group is a logical configuration within a switch that defines which devices can communicate with each other. Switch zone groups allow administrators to segment the SAN into distinct zones, each containing specific devices such as servers and storage devices. This controls the paths that data can take through the network, ensuring that only authorized storage devices can interact. This helps in isolating traffic, reducing congestion, and preventing unauthorized access to sensitive data.

Zoning can be based on various criteria, such as port numbers, or other identifiers, depending on the specific requirements and architecture of the SAN. This logical separation allows for optimizing performance and maintaining the security of the network. While a port group, as discussed above, is also a logical grouping, a zone group is configured at the switch level (e.g., per switch in the SAN) while port groups are configured for storage systems. In some implementations, storage fabric management process 10 processes 308 zone groups in addition to port groups that constrain network connections from a first back-end storage system's port to a second back-end storage system's port only if both followings are met: 1) the ports are in the same port group; and 2) the ports are in the same zone group. To tolerate switch failure, storage processors of storage systems can be configured to include different ports connected to different switches with zones configured. For example, storage fabric management process 10 provides the ability to separate network traffic across port groups and zone groups. While zone groups allow for logical grouping of connections of a switch, the combination of port groups and zone groups allow for directionality among ports of a port group and a zone group. This enables storage fabric management process 10 to separately route network traffic through different switches of the back-end storage fabric.

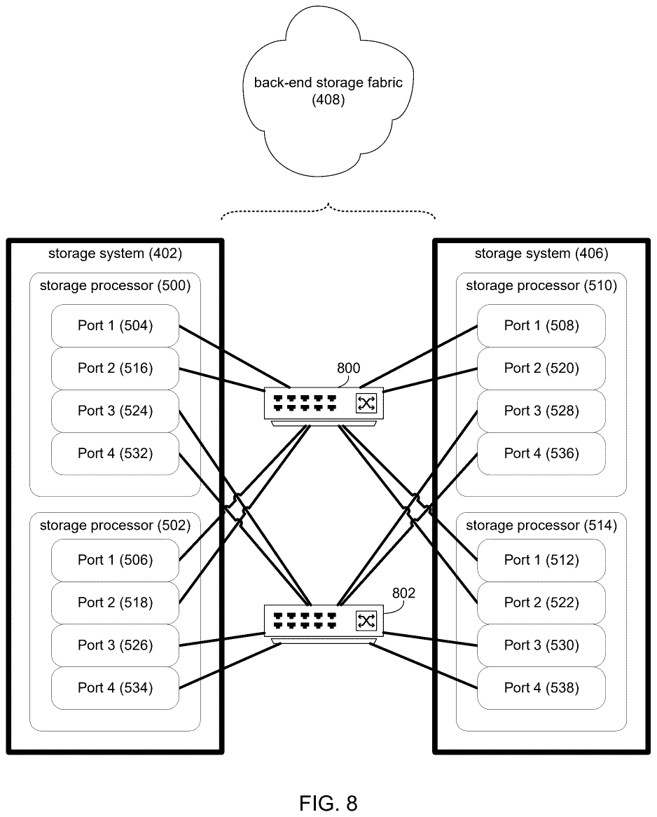

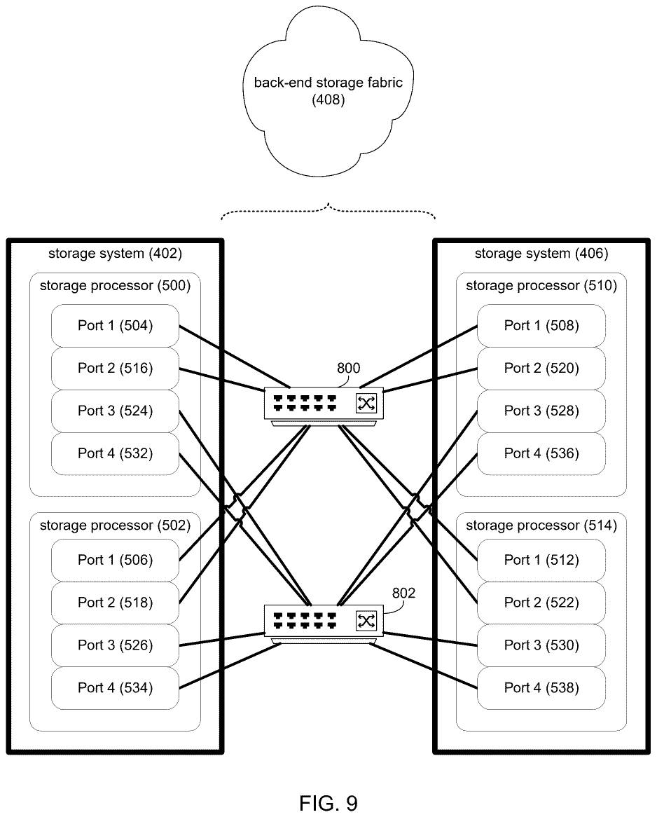

In some implementations, configuring 304 the connection only between the first subset of ports from the first back-end storage system and the second subset of ports from the second back-end storage system includes configuring 310 the connection only between the first subset of ports from the first back-end storage system and the second subset of ports from the second back-end storage system that are included in the zone group. Referring also to FIG. 8, a first switch (e.g., switch 800) is configured with a first zone group including Port 1 504, Port 2 516 of storage processor 500 and Port 1 506, Port 2 518 of storage processor 502 of storage system 402, and Port 1 508, Port 2 520 of storage processor 510 and Port 1 512, Port 2 522 of storage processor 514 of storage system 406. A second switch (e.g., switch 802) is configured with a second zone group including Port 3 524, Port 4 532 of storage processor 500 and Port 3 526, Port 4 534 of storage processor 502 of storage system 402, and Port 3 528, Port 4 536 of storage processor 510 and Port 3 530, Port 4 538 of storage processor 514 of storage system 406. In this example, the zone groups include each port in the port group. However, this is for example purposes only. For instance and as shown in FIG. 9, storage fabric management process 10 configures 310 the connection only between the first subset of ports from the first back-end storage system and the second subset of ports from the second back-end storage system that are included in the zone group without requiring all of the ports from the port group. In the example of FIG. 9, storage fabric management process 10 configures 310 connections between storage systems 402, 406 with the same connections as in FIG. 5.

Accordingly, when configuring 310 the connection only between the first subset of ports from the first back-end storage system and the second subset of ports from the second back-end storage system that are included in the zone group without requiring all of the ports from the port group. Storage fabric management process 10 configures zones between storage systems and port groups. With zone and port group configurations, the storage systems automatically configure connections therebetween.

### General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit”, “module”, or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object-oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general-purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A and B” (and the like) as well as “at least one of A or B” (and the like) should be interpreted as covering only A, only B, or both A and B, unless the context clearly indicates otherwise. The language “one or more of A and B” (and the like) as well as “one or more of A or B” (and the like) should be interpreted as covering only A, only B, or both A and B, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, executed on a computing device, comprising:
identifying a first back-end storage system and a second back-end storage system communicatively coupled together within a storage fabric;
generating a port group including a first subset of ports from a plurality of ports of the first back-end storage system and a second subset of ports from a plurality of ports of the second back-end storage system; and
configuring a connection only between the first subset of ports from the first back-end storage system and the second subset of ports from the second back-end storage system as defined in the port group.

2. The computer-implemented method of claim 1, wherein generating the port group includes defining a directionality of the connection between the first subset of ports of the first back-end storage system and the second subset of ports of the second back-end storage system.

3. The computer-implemented method of claim 2, wherein the directionality of the connection is unidirectional from the first subset of ports of the first back-end storage system to the second subset of ports of the second back-end storage system.

4. The computer-implemented method of claim 2, wherein the directionality of the connection is bidirectional between the first subset of ports of the first back-end storage system and the second subset of ports of the second back-end storage system.

5. The computer implemented method of claim 1, further comprising:
processing a zone group including one or more ports from the plurality of ports of the first back-end storage system and one or more ports from the plurality of ports of the second back-end storage system, wherein the zone group is defined for a switch within the storage fabric.

6. The computer implemented method of claim 5, wherein configuring the connection only between the first subset of ports from the first back-end storage system and the second subset of ports from the second back-end storage system includes configuring the connection only between the first subset of ports from the first back-end storage system and the second subset of ports from the second back-end storage system that are included in the zone group.

7. The computer implemented method of claim 1, wherein the storage fabric is a Fibre Channel (FC) storage fabric, and the first back-end storage system and the second back-end storage system form a FC storage area network (SAN).

8. A computer program product residing on a non-transitory computer readable medium having a plurality of instructions stored thereon which, when executed by a processor, cause the processor to perform operations comprising:
identifying a first back-end storage system and a second back-end storage system communicatively coupled together within a storage fabric;
generating a port group including a first subset of ports from a plurality of ports of the first back-end storage system and a second subset of ports from a plurality of ports of the second back-end storage system; and
configuring a connection only between the first subset of ports from the first back-end storage system and the second subset of ports from the second back-end storage system as defined in the port group.

9. The computer program product of claim 8, wherein generating the port group includes defining a directionality of the connection between the first subset of ports of the first back-end storage system and the second subset of ports of the second back-end storage system.

10. The computer program product of claim 9, wherein the directionality of the connection is unidirectional from the first subset of ports of the first back-end storage system to the second subset of ports of the second back-end storage system.

11. The computer program product of claim 9, wherein the directionality of the connection is bidirectional between the first subset of ports of the first back-end storage system and the second subset of ports of the second back-end storage system.

12. The computer program product of claim 8, wherein the operations further comprise:
processing a zone group including one or more ports from the plurality of ports of the first back-end storage system and one or more ports from the plurality of ports of the second back-end storage system, wherein the zone group is defined for a switch within the storage fabric.

13. The computer program product of claim 12, wherein configuring the connection only between the first subset of ports from the first back-end storage system and the second subset of ports from the second back-end storage system includes configuring the connection only between the first subset of ports from the first back-end storage system and the second subset of ports from the second back-end storage system that are included in the zone group.

14. The computer program product of claim 8, wherein the storage fabric is a Fibre Channel (FC) storage fabric, and the first back-end storage system and the second back-end storage system form a FC storage area network (SAN).

15. A computing system comprising:
a memory; and
a processor configured to identify a first back-end storage system and a second back-end storage system communicatively coupled together within a storage fabric, to generate a port group including a first subset of ports from a plurality of ports of the first back-end storage system and a second subset of ports from a plurality of ports of the second back-end storage system, and to configure a connection only between the first subset of ports from the first back-end storage system and the second subset of ports from the second back-end storage system as defined in the port group.

16. The computing system of claim 15, wherein generating the port group includes defining a directionality of the connection between the first subset of ports of the first back-end storage system and the second subset of ports of the second back-end storage system.

17. The computing system of claim 16, wherein the directionality of the connection is unidirectional from the first subset of ports of the first back-end storage system to the second subset of ports of the second back-end storage system.

18. The computing system of claim 16, wherein the directionality of the connection is bidirectional between the first subset of ports of the first back-end storage system and the second subset of ports of the second back-end storage system.

19. The computing system of claim 15, wherein the processor is further configured to:
process a zone group including one or more ports from the plurality of ports of the first back-end storage system and one or more ports from the plurality of ports of the second back-end storage system, wherein the zone group is defined for a switch within the storage fabric.

20. The computing system of claim 19, wherein configuring the connection only between the first subset of ports from the first back-end storage system and the second subset of ports from the second back-end storage system includes configuring the connection only between the first subset of ports from the first back-end storage system and the second subset of ports from the second back-end storage system that are included in the zone group.
